(19) United States
(12) Patent Application Publication
(10) Pub. No.: US 2004/0219275 A1
(43) Pub. Date: Nov. 4, 2004

(54) Coffee Substitute Product and process for preparing a soybean extract

(76) Inventors: Marina Kushner, Bklyn, NY (US); Alyn Kushner, Bklyn, NY (US)

Correspondence Address: JEFFREY FURR, 253 N. MAIN STREET, JOHNSTOWN, OH, 43031, US

(21) Appl. No.: 10/249,689

(22) Filed: Apr. 30, 2003

(51) Int. Cl. A23F 5/00

(52) U.S. Cl. 426/596

(57) ABSTRACT

A novel system for producing a high quality soybean extract using espresso technology is provided as well as novel soybean compositions for use in such system and a process for preparing a soybean extract of consistently high quality using a coffee brewing device, and particularly, an espresso machine. This novel drink is especially suitable for individuals who suffer from conditions making them coffee intolerant, e.g., pregnancy, or those who suffer form hypoglycemia, hypertension, arrhythmia, insomnia, or gastric irritation

### BACKGROUND OF INVENTION

The present invention generally relates to a product and process for preparing a soybean extract. More particularly, the present invention relates to a novel soybean extract system including a soybean composition for use in such system and to a process for preparing a soybean extract of consistently high quality using a coffee brewing device, and particularly, an espresso machine.

### PRIOR ART

In recent years, the coffee beverage market has enjoyed increased favor worldwide. Numerous espresso bars and coffee shops have capitalized on the popularity of coffee-based beverages (e.g., espresso, cappuccino, latte), and are now beginning to explore other types of beverages.

Coffee possesses a pleasant aroma and is an enjoyable taste experience that many believe reduces stress during the workday. Consequently, the United States consumes about 70% of the world's coffee crop, or about 3 cups a day for each American. Coffee beverages contain about 100 mg caffeine per cup (per 8 ounces). Coffee stimulates the central nervous system, increases diuresis, dilates the vascular system and combats sleep, which is possibly linked to the caffeine-mediated glycogen sparing effect secondary to an increased rate of lipolysis. Thus, many decaffeinated coffee procedures have been taught to reduce the caffeine content and its side effects. In U.S. Pat. No. 4,871,555 in 1989, Hallah et al provided over-roast (400-450.degree. F. for 45-60 minutes) and extract to obtain an instant coffee substitute from soybeans. Kay even discussed a preparation of a coffee substitute with soybeans in 1980 (U.S. Pat. No. 4,288,409) and further mixed the product with other nutritional supplements (e.g. dandelion root) and conventional coffee to form a beverage. In addition, Shirbroun teaches beverage made largely from soybeans (U.S. Pat. No. 4,187,324, 1980).

However, Hullah et al, Kay, and Shirbroun never suggested or attempted to make an independent satisfactory beverage. Part of the problem was the lack of food grade soybeans. Although any soybean variety can be used to make soyfoods, certain varieties are preferred. Seed (grain) characters believed to be important for production of tofu and other soyfoods include high content of protein, especially soluble protein, large seed weight, acceptable color, and high sugar content of these characteristics, high protein content is probably the most important. Also, the protein content of the soybeans is strongly related to the protein content (and therefore the nutritional quality) of the food product.

It is well known that coffee aroma arises from more than 500 volatile compounds and complicated process. Therefore, the fact that those prior products lack the attractive aroma is not entirely surprising in light of the methods employed to process soybeans etc.

The desire to be able to quickly produce a wide variety of coffee beverages having a consistent, reproducible, high quality has led to the development of a variety of coffee/espresso machines and accessories, as well as expertise in the coffee beverage industry. With the expansion of the soybean market, there is clearly a similar need to provide expertise and product technology that will extend the retail coffee brewing industry beyond the traditional “coffee bag”.

With the number of cafes, restaurants, and retail outlets preparing and serving beverages which are prepared in espresso machines, there was a need-for standardizing the preparation of espresso beverages to compensate for the wide variations in experience among espresso machine operators and in the espresso machines themselves. In response to this need, a variety of espresso machines and coffee brewing containers, or “pods”, have been disclosed which are meant to provide a foolproof, consistent means for making an espresso drink. For example, Illy et al. U.S. Pat. No. 4,254,694, 1981; Fond et al., U.S. Pat. No. 5,637,335, 1997; and Cisaria et al., U.S. Pat. No. 5,638,741, 1997; disclose various espresso machines, coffee “pods”, and “pod adapters” for espresso machines. Typically, a coffee pod as described in the above-referenced patents consists of an enclosed water-permeable pod or package which contains a pre-measured amount of ground coffee that is preferably compressed to provide a consistent measure of coffee for production of espresso beverages. These coffee pods and the espresso machine adaptors that are designed to accommodate them are intended to provide a standardized espresso or coffee that can be used to make a variety of coffee drinks.

In the retail market, it would be desirable to be able to use existing coffee/espresso technology to produce high quality soy-based beverages, since it would be expensive and impractical to design an entire new line of machines and products suitable for brewing high quality soybeans. None of the above-mentioned references, however, discloses how to produce a consistently high quality soybeans using the technology designed for coffee and espresso beverages. Indeed, the previously described “pod” products and coffee grinds can not be simply extrapolated to the production of raw soybeans in an espresso machine. For example, a soy “pod” that is made using the guidelines disclosed for coffee, or merely filled with any soybean blend, when extracted in an espresso machine, produces a coffee that is weak and tasteless. Moreover, the flavor of any additional flavors in a soy blend produced in an espresso machine may be lost.

Since the market for a variety of soy-based beverages that can be prepared in seconds continues to increase, there is a need to provide a product and method of producing a soy extract system for use in the production of a variety of soy beverages which takes advantage of espresso brewing technology. Such products and methods should be consistent, fast, easy, cost efficient, and produce a high quality soybean extract for use in a variety of beverages.

### SUMMARY OF INVENTION

It is an object of the present invention to produce a hot coffee-like beverage which overcomes the above-noted deficiencies of prior art. It is another object of the present invention to produce a hot beverage having the flavor and aroma of coffee.

It is another objective of the present invention to produce a hot beverage having a novel aroma from a plant grown in the United States which is in ample supply, healthy, and even better accepted than tropical coffee.

It is an objective of the coffee substitute to provide a process for a non-caffeine beverage with optimal calorie distribution. Such a hot drink provides an excellent means to eliminate waste from the body. It further acts as a buffer to prevent discomfort when the user is consuming many nutritional supplements at one time. Additionally it aids in preventing hypoglycemia and helping to reduce hyperglycemia, hypercholesterol and overweight.

These and other objects are achieved by the present invention. In the method of the present invention, food-grade soybeans, whole or defatted, are preheated to near roasting temperature and then roasted for shorter times than are conventionally employed. The product is brewed conventionally and the extract from brewing is dried by conventional methods to produce an instant coffee-like beverage. This instant coffee-substitute has excellent flavor and aroma.

The current invention is a soybean extract system for production of a serving of soybean extract in a coffee brewing device and the product produced. The system consists of a soybean extraction container for containing a soybean composition with the soybean extraction container comprising a sealed body having at least one internal compartment, and the internal compartment containing said soybean composition; wherein the sealed body is constructed of a water-permeable material which allows flow of a fluid through said sealed body to produce a soybean extract from the soybean composition.

This highly nutritional beverage can be consumed independently. Edible soybeans are used for the processing of the many different soyfood products. Soyfoods are rapidly becoming a part of many American's healthy diets. Soybeans have been identified as a food source that has health benefits. In October of 1999, the Food and Drug Administration reported that 25 grams of soy protein daily as part of a diet low in saturated fat and cholesterol may reduce the risk of heart disease. The New England Journal of Medicine published a study in 1995 that concluded a diet with soy protein reduced serum cholesterol in people with moderately high to high cholesterol. In addition, this report indicated that the inclusion of soy protein in the diet lowered the LDL or “bad” cholesterol but not the HDL or “good” cholesterol. It is especially suitable for individuals who are suffer from conditions making them caffeine intolerant, e.g., pregnancy, or those who suffer from hypoglycemia, hypertension, arrhythmia, insomnia, or gastric irritation. Other features and advantages of the coffee substitute will become more apparent with the accompanying method, which illustrates, by the way of example, the principle of the invention.

Since the market for a variety of soy-based beverages that can be prepared in seconds continues to increase, there is a need to provide a product and method of producing a soybean extract system for use in the production of a variety of soy beverages which takes advantage of espresso brewing technology. Such products and methods should be consistent, fast, easy, cost efficient, and produce a high quality soy extract for use in a variety of beverages.

### BRIEF DESCRIPTION OF DRAWINGS

Without restricting the full scope of this invention, the preferred form of this invention is illustrated in the following drawings:

FIG. 1 shows the process; and

FIG. 2 shows the extraction chamber.

### DETAILED DESCRIPTION

The following description of a hot coffee-like beverage and process to create it is demonstrative in nature and is not intended to limit the scope of the invention or its application of uses.

The preferred basic starting materials for the present invention are food grade soybeans because of higher protein content and higher sugar content.

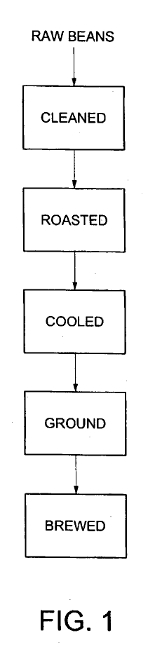

As shown in FIG. 1, when raw soybeans are used as the starting product, the raw beans are first cleaned to remove stones, other seeds, wood, etc. In the preferred embodiment, the soybeans may be cleaned and sized by screening, cyclone separation, aeration and/or magnetic means. The whole beans are also thoroughly rinsed, by a tumble/spray or vat immersion process, to remove soil.

After washing, the beans are drained. As shown in step 25, the soybeans are roasted in a conventional drum roaster, such as an industry standard drum roaster like the Probat. Drum roasting is preferred since its lacks perforations commonly found in conventional roasters. The roasting step is both time and temperature dependent. Higher roasting temperatures and shorter roasting times are preferred to avoid over roasting which creates a “burnt” taste. Since its not being prepared for an instant it is the preferred method. Roasting should be performed at 350.degree.-400.degree. F., preferably 425.degree.-475.degree. F. and most preferably at 425.degree. F. The time of roasting, measured from the time the temperature inside of the beans is about equal to the roasting temperature, is about 15 minutes in the preferred embodiment.

Time for roasting can vary based on differentials in weather, air pressure, air density and moisture affect coffee roaster efficiency, just like they affect the efficiency of an automobile or airplane engine. For example, higher altitude or humidity will require more roasting time to create the same coffee beans as a lower altitude, low humidity environment.

10 to 11 minutes—medium roast; a full-bodied roast that is sometimes called “city roast”

12 to 14 minutes—dark roast; known as French or Viennese coffee; like the specialty coffees of the Pacific Northwest

15 minutes—darkest roast; known as espresso roast (The beans actually begin to smoke, and the sugars in the beans caramelize and burn.)

Roasting temperature and time, based on atmospheric conditions on any given day will give consistently roasted, flavored coffee beans. The beans go through two “crack” stages during the roasting. Initially, as the water within the beans begins to boil, they expand a little, as moisture is released. During the second crack, the sugars and oils in the beans boil, eliminating some flavors and adding some flavors. At these crack points, the beans give off little popping noises, like popcorn. The precise moment to end each roast depends on the type of bean. The desired color and the amount of oil showing are indicators. Because hot beans will continue to cook a little after they are dropped out of the roaster, this is anticipate in the timing.

After roasting, the beans are cooled to ambient temperatures and ground by conventional means, for example, in a Grindmaster Mill or a blender. In the preferred embodiment, the size of the grind is determined by Tyler sieves to allow optimum extraction of flavor, aroma and color. The optimum size for extraction (generally expresso ground) must be balanced against the necessity of preventing clogging during the filtering of the extract due to the oils and fats in the beans. The hulls may be removed prior to grinding, but it has been found that flow during subsequent filtering of the extract is speeded when the hulls are left on so the hulls are left on in the preferred embodiment.

As discussed above, the present inventors have discovered that adaptation of espresso technology, and particularly coffee “pod” technology, to the production of quality soybean extracts can not be accomplished by following the guidance provided for coffee pods and espresso brews as disclosed by others prior to the present invention. The present inventors disclose herein a soybean extract system which includes soybean extraction containers (e.g., soy pods) containing novel soybean compositions and a method of using the same in a coffee brewing device, and particularly, an espresso machine, to produce a high quality, consistently reproducible soybean extract.

One embodiment of the present invention, relates to a soybean extraction system for producing a soybean extract in a coffee brewing device, and particularly, an espresso machine. Such a soybean extraction system includes: (a) at least one soybean extraction container for containing a soybean composition and (b) the soybean composition.

In the preferred embodiment, a soybean composition comprising from about 2 grams to about 14 grams of soybeans having a particle size of from about 0.10 mm to about 0.65 mm is used.

According to the present invention, a soybean extraction container can be any container which includes a sealed body having at least one internal compartment for containing a soybean composition. The sealed body is constructed from a water-permeable material which allows a liquid (e.g., water) to flow through the sealed body into the internal compartment such that the liquid contacts the soybean composition, thereby extracting the soybean composition into the fluid, and then exits the sealed body as a soybean extract. The water-permeable material suitable for construction of the sealed body can be any water-permeable material that is suitable for use with a food product, such as filter paper, permeable plastic, tight weave metal mesh, nylon and linen. The water-permeable material can be flexible or rigid. In the preferred embodiment the flexible material is filter paper. An example of a rigid material is tight weave metal mesh. In a preferred embodiment, a soybean extraction container is formed from filter paper.

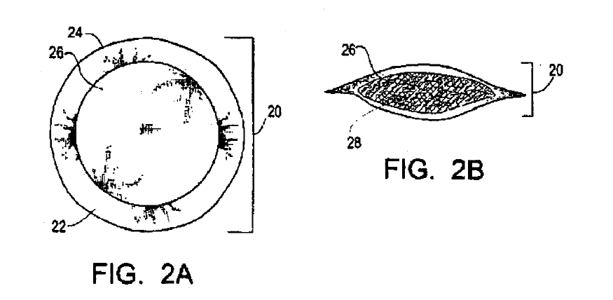

The soybean extraction container can be any shape or configuration suitable for use in a coffee brewing device. For example, a soybean extraction container useful in the present invention can be in the shape of a circular pod, a square pod, or a basket. Containers suitable for use as a soybean extraction container in the present invention are disclosed, for example, in U.S. Pat. No. 5,637,335, supra, or in U.S. Pat. No. 4,254,694, supra, which are incorporated herein by reference in their entirety. Preferably, a soybean extraction container useful in the present invention is a circular pod shape. FIGS. 2A and 2B illustrate a circular pod soybean extraction container of the present invention. FIG. 2A is a top view of a single soybean extraction container (20), showing a sealed body (22) comprised of a water-permeable filter paper, having a sealed edge (24) enclosing an internal compartment (26) which contains the soybean composition. FIG. 2B is a cross-sectional side view of the same single extraction container (20), showing the soybean composition (28) contained within the internal compartment (26).

The term “sealed body” with regard to the soybean extraction container means that the container forms an internal compartment, or space, which completely contains the soybean composition and prevents the soy composition from escaping from the internal compartment. As such, the sealed body is can be “sealed” by any means which accomplishes this goal, such as by an adhesive seal around the periphery between sheets of filter paper, or simply by the contact of the rims of two “basket-shaped” metal mesh bodies which are connected to each other by a hinge. An adhesive seal is used in the preferred embodiment.

### Operation

There are three basic types of espresso machines: the boiler, the pump/boiler, and the pump/thermoblock system. The boiler method, while relatively inexpensive, does not generate optimum pressure and often heats water to too high a temperature. The pump/boiler method, although preferable to the boiler, allows too much fluctuation in temperature and pressure.

The pump/thermoblock heating system is the most reliable choice and is used in the preferred embodiment, providing optimum temperature and pressure at consistent levels. The Nespresso System features a microchip-monitored pump that extracts espresso at 11 to 15 bars of pressure. Nespresso's thermoblock heating element maintains a continuous water temperature, controlled by a thermostat, within the ideal range of 187 to 196 degrees Fahrenheit.

Another consideration for home espresso lovers is making sure the machine does not reuse water. The machine should discharge excess water after each espresso, That way, fresh water is used every time.

In choosing a machine, the first step is to remember that true espresso requires hot, not quite boiling water. “Boiling water or steam burns soybean's delicate essences. Espresso machines should generate an ideal water temperature of 187 degrees to 196 degree Fahrenheit. A fine soy based blends require a lower, narrower brewing temperature, around 192 F or 189-194 F, to produce that smooth, perfect cup of espresso.

Next is the pressure. Steam driven machines generally exert only 3 atmospheres (bars) of pressure, which is produced by simply heating the water in a boiler. Most steam driven machines produce temperatures too hot for quality espresso brewing; the result can be a scalded soy, a bitter tasting drink and the absence of fine crema. While there have been improvements made to steam machines, the espresso they make is still not as intense in flavor and aroma as that made by pump machines. Steam driven machines also are less convenient because they require the user to pour water into a tank (boiler), screw a cap on, and wait for it to heat up. If there is a need to add more water to the machine, someone must wait for it to cool down before unscrewing the lid otherwise it may cause serious burns. In short, low cost steam driven “espresso makers” produce bad tasting soy drink that has no resemblance to fine espresso.

Pump driven espresso machines, on the other hand, produce the cafe quality espresso consumers are seeking, offering a higher brewing pressure, better regulated temperature, and instant repeat of a brewing cycle. Nearly all commercial espresso machines found at local coffee bars are pump driven. If someone has been using a steam model and could not reproduce the coffee they were getting from a coffee bar, this is why!

While 9 bars (explained below) of pressure is the minimum amount of pressure desired to produce a quality drink, most home pump machines can produce anywhere from 9 to 18 bars of pressure.

Pressure produced by any pump, including those found inside of pump driven espresso machines, is given a value or strength. This value is measured in “bars.” One bar is equal to 0.99 atmospheres. One atmosphere is equal to 14.72 lbs. per square inch and is the pressure exerted by the earth's atmosphere or air around you at sea level. When you are standing at sea level, the pressure of the earth's atmosphere is exerting nearly 15 pounds per square inch against your body.

In order for good espresso to be produced from a pump driven espresso machine, the pump must be able to produce at least 9 to 10 bars of pressure. Good espresso is produced by forcing boiling water through the portafilter at 9-10 bars or nearly 9-10 atmospheres.

Commercial espresso machines use a rotary or centrifugal pump that spins to produce pressure. Rotary pumps can be controlled and their pressures can be maintained. When everything is working perfectly, a golden layer know as the “crema” sits atop the espresso.

The crema seals the espresso's aroma in the cup. Crema is the ultimate test of espresso quality.

### Alternative Embodiment

In an alternative embodiment, the soybean composition is selected from the group consisting of dark roasted soybeans producing a dark strength soy coffee, or medium roasted soybeans producing a medium strength soy coffee.

In an other embodiment, the soybean composition can be placed in filter pack/pod for coffee makers too (i.e. bag make 12 cup brewfilter packs it is made up of in the preffered embodiment of roximately 0.80 oz-15 grams of soybeans and 0.2 grams of paper, both natural products that do not harm the environment. Thies range should cover all forms of permeable filters which can be used for in-room hotels, airline flight packs, food service (12-up), retail & food service pods s.

Also the soybean composition can be placed in a pourous pouch (just like tea) for single cup brewing. It can have a string attached (similiar to tea) or not. It is designed to make a single 5.5 ounce of soy coffee by dunking in boiling/hot water. These pourous pouches are well know in the industry and therefore are not descibed in detail here.

### Advantages

The previously described version of the present invention has many advantages, including many elements missing in all prior art. It provides a hot beverage having a novel aroma from a plant grown in the United States which is in ample supply, healthy, and even better accepted than tropical coffee.

Although many features, functions, and advantages of the present invention have been described in this specification, together with details of the structure of specific embodiments thereof, the description as a whole is illustrative only, and substitutions may be made in detail, especially in matters of shape, dimension and arrangement of elements within the principles of the invention to the full extent indicated by the broad, general meaning of the terms in which the claims are expressed. Therefore, the point and scope of the appended claims should not be limited to the description of the preferred versions contained herein.

1-38. (canceled)

39. A soybean extract system for production of a serving of soybean extract in a coffee brewing device, comprising: a soybean extraction container for containing a soybean composition, said soybean extraction container comprising a sealed body having at least one internal compartment, said internal compartment containing a soybean composition; wherein said sealed body is constructed of a water-permeable material which allows flow of a fluid through said sealed body to produce a soybean extract from said soybean composition; and wherein said soybean composition is comprised from about 2 grams to about 10 grams of soybeans having a particle size of from about 0.10 mm to about 0.65 mm.

40. The soybean extract system of claim 39, wherein said soybean composition is selected from the group consisting of dark roasted soybeans producing a dark strength soy coffee, and medium roasted soybeans producing a medium strength soy coffee

41. The soybean extract system of claim 39, wherein said soybeans producing a dark strength soy coffee are selected from the group consisting of food grade soybeans and mixtures thereof.

42. A product made by the method of claim 39.

43. The soybean extract system of claim 39, wherein said soybean composition is comprised of soybeans that have been roasted at a heat of 425 degrees F. to 475 degrees F.

44. The soybean extract system of claim 23, wherein said soybean composition is comprised of soybeans that have been roasted for a 15 minute period.

45. The soybean extract system of claim 23, wherein said soybean composition is comprised of soybeans that have been roasted at a heat of 425 degrees F. to 475 F. degrees that have been roasted for a 15 minute period.
